(19) United States
(12) Patent Application Publication
(10) Pub. No.: US 2006/0027792 A1
(43) Pub. Date: Feb. 9, 2006

(54) Carbon composite near-net-shape molded part and method of making

(76) Inventors: Jonah V. Butcher, Asheville, NC (US); Kenneth R. Butcher, Hendersonville, NC (US); Feng Chi, Greer, SC (US); Donald E. Floyd II, Greenville, SC (US); David P. Haack, Hendersonville, NC (US); Mark A. Janney, Hendersonville, NC (US); Nathan A. Pressley, Zirconia, NC (US); Earl R. Torre JR., Travelers Rest, SC (US)

Correspondence Address: NEXSEN PRUETT JACOBS & POLLARD, 201 W MCBEE AVENUE, SUITE 400, GREENVILLE, SC, 29601, US

(21) Appl. No.: 11/191,737

(22) Filed: Jul. 28, 2005

Related U.S. Application Data
(60) Provisional application No. 60/591,718, filed on Jul. 28, 2004.

(51) Int. Cl. H01B 1/12

(52) U.S. Cl. 252/500

(57) ABSTRACT

A carbon-based composite part and process for making the part. The composition comprises 35 to 75 wt % graphite powder; 20 to 50 wt % resin powder; and 5 to 25 wt % discontinuous carbon fibers no longer than 3 mm.

### CROSS-REFERENCE TO RELATED APPLICATIONS

The present application claims priority to U.S. Provisional Appl. Ser. No. 60/591,718 filed Jul. 28, 2004 which is pending.

### BACKGROUND

The present invention is related to carbon composite materials and the method of forming them.

Carbon-based materials are widely used in various areas of commerce including: electrical contacts such as motor brushes; electrodes such as batteries, fuel cells, electric arc furnaces, aluminum smelting; high temperature structural components such as furnace fixtures and linings, missile nosecones, furnace linings and glass handling tools; containers such as for special chemical processes or molten metal crucibles and mechanical seals such as bearings and piston rings.

The presence of fibers in the composite increases its strength relative to char-bonded graphite-based materials lacking fibers. Therefore, the fiber-containing parts are stronger at a given density than are the non-fiber containing parts.

There are few near-net-shape forming processes for making graphite parts. Most graphite components are machined from large blocks of graphite that are either isomolded or extruded. Machining is a slow and an expensive process.

Net shape molding of graphite-based composites can greatly reduce both the cost and the time required to fabricate parts. Furthermore, net shape molding can produce reinforcement of the part caused by alignment of the fibers with the contours of the mold that is not achievable in non-molded parts. Furthermore, molding can create unique microstructures in the molded part

### SUMMARY OF THE INVENTION

It is an object of the present invention to provide a composition, and method, for forming a near-net shape carbon composite.

It is another object of the present invention to provide a composition, and method, for forming a near-net shape carbon composite which has improved strength at a given density.

A particular feature of the present invention is the lower density which can be obtained with adequate strength.

These and other advantages, as will be realized, are provided in a carbon-based composite part and process for making the part. The composition comprises 35 to 75 wt % graphite powder; 20 to 50 wt % resin powder; and 5 to 25 wt % discontinuous carbon fibers no longer than 3 mm.

Yet another embodiment is provided in a method for making a carbon-based composite with 35 to 75 wt % graphite powder; 20 to 50 wt % resin powder which produces ≧25 wt % char on pyrolysis; 5 to 25 wt % discontinuous carbon fibers; 0 to 20 wt % addition of one or more fugitive forming fibers; 0 to 15 wt % addition of one or more fugitive thermoplastic polymer; 0 to 5 wt % addition of one or more flocculants; 0 to 1 wt % addition of one or more foam control agents; and 0 to 1 wt % addition of one of more wetting agents. The method includes:
mixing all components in an excess of water to produce a homogenous suspension;
filtering the suspension to form a filter cake;
drying the filter cake;
molding the filter cake under pressure at a specified temperature to form a desired shape; and
pyrolyzing the molded part at a temperature and for a time to substantially remove volatile components from the part.

Yet another embodiment is provided in a molded carbon-based composite part with 35 to 75 wt % graphite powder; 20 to 50 wt % resin powder; 5 to 25 wt % discontinuous carbon fibers no longer than 3 mm and the fibers substantially following the surface contours of the part.

### SUMMARY OF THE FIGURES

FIG. 1 is a graphical representation of the water permeability dependence upon material density.

FIG. 2 is a graphical representation of the product bubble pressure dependence upon material density.

FIG. 3 is an optical micrograph of a molded and chemical vapor deposition (CVD) sealed bipolar plate material.

FIG. 4 is a scanning electron micrograph (SEM) showing molded microstructure of plate channel.

### DETAILED DESCRIPTION OF THE INVENTION

A carbon composite preform and compression-molded part are described along with the method for making each.

The carbon composite preform comprises a matrix, containing a mixture of graphite powder, discontinuous graphite (or carbon) fibers, and a resin that produces a carbon char on pyrolysis. Various fugitive components, which may aid in forming, are added to this matrix. These fugitive components do not substantially contribute to the final carbonaceous product. The fugitive processing aids may include organic fibers, organic resins, pH adjusters, flocculants, dispersants, foam control agents, and other additives common to the processing of particles in fluid suspensions. The preform is made using a papermaking, slurry molding, or pulp molding process in which all of the ingredients identified above are mixed together in a liquid and then formed onto a porous substrate by a filtration process. After forming, the preform is dried before it is molded to final shape.

The molded carbon composite part is made by applying pressure at a controlled temperature to the carbon composite preform in a die of the preferred shape. The resulting part conforms to the shape of the mold. In addition, because there is significant flow during molding, the graphite fibers, and in some cases the graphite particles, tend to align themselves with the contours of the mold. This provides a unique microstructure and a unique reinforcement of the part that cannot be achieved by machining the part from a graphite blank made by isomolding or extrusion. The fibers substantially follow the surface contours of the part thereby greatly increasing the strength. Substantially following the surface is defined as the majority of the fibers align with the surface under optical microscopic observation.

After molding, the part is pyrolyzed to substantially remove the fugitive forming aids and to convert the carbon-precursor resin to a residual carbonaceous char. The char bonds together the graphite powder and discontinuous graphite fibers into a strong composite. After it is fired at high temperature, the part can be further processed by infiltrating the porous structure with additional material by liquid or vapor routes, eg by chemical vapor infiltration or by liquid resin infiltration (REFS) to increase its density. Alternatively, the part can be coated by a chemical vapor deposition process to seal its surface; the coating can be carbon or other compatible coating such as metal carbides, nitrides, etc.

The carbon composite part in the as-fired state is electrically and thermally conductive, can be both porous and permeable to fluids, ranges in density from 0.4 to 1.6 g/cm³, and can be sealed to be hydrogen impermeable.

Particular advantages of the present invention include: formation of net-shape molding of fiber reinforced graphite composites; high strength-to-weight-ratio graphite; highly electrically and thermally conductive and high strength in a low density part. Reduction of density relative to typical graphites range in density from 1.6 to 1.9 g/cm³ to a density from 0.4 to 1.6 g/cm³.

The graphite-based composite preferably comprises 35 to 75 wt % graphite powder; 20 to 50 wt % organic resin or polymer powder and 5 to 25 wt % discontinuous graphite fibers. The matrix composition largely remains after pyrolysis.

The graphite powder forms the major phase in the composite after pyrolysis and can be synthetic, natural or a blend of both. The average particle size of the graphite powder is preferably in the range of 5 μm to 200 μm. High purity graphite, >99 wt %, is preferred for many end uses, but high purity is not required to produce the product.

The resin bonds the composite together after compression molding. The resin produces a carbon char on pyrolysis that bonds the graphite powder and the graphite fibers together into a strong composite. The resin is preferably selected from phenolic, pitch, epoxy, furfural and melamine. The resin is preferably chosen to produce >25 wt % carbon residue upon pyrolysis and should provide thermoplastic flow during compression molding. Blends of two or more resins can be used in the composite.

The carbon fiber provides reinforcement for the composite, strengthens the composite and reduces shrinkage during pyrolysis. Carbon fibers may be derived from various carbon precursors including polyacrylonitrile (PAN) and pitch. Carbon fiber diameters should be between about 1 and 30 μm with average lengths of between 50 and 1000 μm.

The components are blended together in an excess of liquid, typically water, and formed into a shape by a combination of pulp molding to make a preform followed by compression molding or other pressure forming technique to form the preform into the desired shape and to partially densify the part. The preform is then fired to convert the resin to a carbon char, which fully develops the properties such as strength, stiffness, conductivity, etc. of the composite.

Processing aids may be added to the above-described materials that assist in forming the matrix into a usable configuration.

Organic forming fibers may be incorporated at 0 to 20 wt % to aid filter formation of the preform sheet, to increase strength of preform sheets before drying or to modify pore size or pore volume of the fired part. Organic forming fibers can be natural or synthetic and selected from the group including cellulose, including wood and cotton, and cellulose derivatives; acrylic and modacrylic; polyolefin; polyester; nylon; polyvinyl alcohol; aramid and liquid crystal resins. Organic forming fiber length should be between 50 μm and 20 mm with a preferred diameter of between 0.1 μm and 50 μm. Forming fibers are substantially removed from the part during pyrolysis. More than one fiber may be included in the batch composition.

Thermoplastic flow enhancer may be added at about 0 to 15 wt % to increase flow of the preform during compression molding or to modify pore size or pore volume of the fired part. Flow enhancer can be either particles or fibers and are preferably selected from the group including polyolefins, cellulosic polymers, phenoxy polymers and the like.

Flocculant may be added at about 0.01 to 5 wt % to modify the interactions of the graphite particles, the resin particles, and the graphite fibers or to prevent segregation during filter forming and to increase the rate at which water can be drained from the filter cake. The flocculant can be a high molecular weight polymer in solution e.g., polyacrylamide and polyethylene oxide polymer. Wetting agents or foam control agents may be added in preferred amounts of 0 to 1 wt %.

The forming process proceeds according to the following steps:
1—Weigh out all components.
2—Mix fibers in an excess of water (typically 0.05 to 5 wt % solids) using a high intensity shear mixer (mixer should be typical for pulp processing—deflaker, disc mill, pin and cage, or similar mixer) for a period of time sufficient to wet out and fully disperse fibers in water—typically between 5 and 60 min.
3—Add remaining components to an excess of water (typical solids loading in water is 0.1 to 7 wt %) with adequate mixing. For best results, the polymeric flocculants (polyacrylamide or polyethylene oxide polymers) are added after all components have been adequately mixed together, just before the suspension is formed into a sheet.
4—Form a sheet by vacuum or pressure filtering the suspension through an appropriate screen or other medium that will separate the water from the solids.
5—Dry the sheet.
6—Compression mold the sheet to form the appropriate shape.
7—Fire the part to substantially remove the processing aids (dispersants, flocculants, forming fibers, thermoplastic flow enhancers, wetting agents, etc.) and to convert the carbonaceous binder (phenolic resin or other carbon-yielding polymer) to a carbon char.
8—If parts sealed against gas permeation are desired, CVD coat the part with carbon, or impregnate the part with a polymeric resin to seal the part.

A highly important portion of the development activity is the development of a uniform sheet in a process that has the potential to be highly consistent and is fast enough for higher production rates. This development takes a significant departure in method from the prior art, and is also significantly different from paper manufacturing. In this method, an ingredient mixture with proper chemistry is introduced in a controlled manner to form a single sheet of material that requires no machining—target weight is achieved in the process. The sheet is then removed, dried, pressed, and carbonized (then CVD sealed for non-porous materials). The sheet formation process drives product quality through establishing tight limits on sheet weight and on within-sheet uniformity. Poor quality sheets lead to highly variable and poor quality finished product.

Contemplated embodiments include the use of pitch-based fiber in place of PAN-based fibers; the use of other thermosetting resins in place of phenolic resin including melamine, furfural, epoxy, etc.; the use of thermoplastic resins in place of phenolic resin including coal-tar pitch, petroleum pitch, etc. and the use of coke powder in place of graphite powder, then firing to very high temperature to graphitize the coke.

The new concept allows for more rapid evaluation of materials and serves the purpose of making a high quality sheet to net thickness in a much faster-than-batch process. At this stage, the system was begun with a simple portable sheet-forming cart that could be connected to a vacuum source and manually filled with sheet slurry. Hardware including automated batching of the suspension into the forming head, and a system of tanks to premix and agitate the suspension is preferred. An electronic system designed to control the level in the batching tank prior to release into the forming head is preferred. This encourages the formation of consistent sheets through the course of operation. The system also controls sequencing of mixer operation, suspension release to the forming head, vacuum application, etc.

Flocculation of the suspension is a highly important feature in this type of material forming. If the solid materials in the water-suspension can be encouraged to flock together into small groupings of particles, then the sheet forming can be significantly more rapid. The chemistry of the suspension can have a significant effect upon product uniformity. Small flocks that are free from interaction with other flocks lead to a highly uniform sheet, while flocks that “cluster” in the suspension tend to form sheet with numerous “hills and valleys” leading to non-uniform sheets.

It has been found that introducing various thermoplastic additives to the composition such as flow enhancers, pore formers and forming fibers can assist with material flow in the die press, leading to more easily formed flow channels and higher quality materials.

The thermoplastic materials, because they generally yield no carbon residue during the carbonization process, have been found to contribute to the porosity of the material. Pores have been found to yield porous materials with enhanced permeability.

The forming fibers provide for efficient formation of sheets with good handling strength and particle retention, and provide additional porosity for the materials.

Issues associated with carbonization including part shrinkage, part blistering, part warpage, and potentially part properties including strength and conductivity are avoided with the present invention. In the molded part development, carbonization in vacuum furnaces has been the standard process. Part fixtures that support recessed areas on the plates (such as edges where gaskets may be applied to the finished part) have been designed to eliminate any issues with part warping in those areas of the plate.

The sealing of the product is through carbon deposition in a vacuum furnace. Specific conditions for sealing provide a uniform, continuous layer of carbon onto the part surface, generating a sealed part. The specific furnace temperatures, operational pressures, and gas flow rates (as well as the furnace design and operating characteristics) effect the deposition process and the coating on the part.

The invention will be demonstrated by the following examples intended to be illustrative but not limiting. The following examples illustrate the range of compositions and the properties achievable in this composite material. The properties are a strong function of the density of the composite. Generally, strength and electrical and thermal conductivity increase with density. Liquid permeability tends to decrease with increasing density. Pore size, as measured by bubble pressure, also tends to decrease with increasing density.

### EXAMPLE 1

This example shows the properties of a preferred plate material. A composition was prepared comprising 52 wt % natural graphite powder, 30 wt % phenolic resin powder, 15.5 wt % milled graphite fiber and 2.5 wt % chopped organic fibers.

The materials were mixed together with deionized water in a suspension of nominally 2% solids by weight. The mixture was continuously agitated to ensure that uniform conditions were maintained before distributing the mixture suspension to a sheet forming device. Sheets of material were formed nominally 21″×12″ in dimension, and weighing approximately 400 grams when dry. The wet sheets of material were dried in a belt dryer. After drying, the sheets were trimmed to final dimension and pressed in a hot press to compact the material, melt and cure the resin and achieve a good plate surface finish and consistent thickness. The pressed plate was then carbonized in a carbonizing furnace at a temperature of 1,300° C. and a pressure of 1 Torr. A group of materials were measured for material properties after the carbonization step. These properties are shown below. A second group of materials were Chemical Vapor Deposited (CVD) coated with thermally deposited carbon derived from methane at an operating temperature of 1,400° C. and a pressure of 7 Torr after the carbonization step to seal the materials against gas permeation. Strength measurements and other properties were determined following the CVD coating step and the results shown in the following table:

| | |
|---|---|
| Density | 1.25 to 1.29 g/cm³ |
| Electrical conductivity | 440 S/cm |
| Thermal conductivity | 36 W/m-K (in-plane) |
| | 6 W/m-K (through-plane) |
| Thermal expansion | 6.2 × 10⁻⁶/° C. |
| Average strength (as-carbonized) | 5200 psi 4-point MOR 2 mm × |
| | 4 mm × 20 mm/40 mm span |
| Specific strength (as-carbonized) | 4160 psi/(g/cm³) |
| (strength/density) | |
| Average strength | 7410 psi |
| (after CVD coating with pyrocarbon) | 4-point MOR |
| | 2 mm × 4 mm × |
| | 20 mm/40 mm span |
| Specific strength | 5880 psi/(g/cm³) |
| (after CVD coating with pyrocarbon) | |
| (strength/density) | |

### EXAMPLE 2

A material composition that embossed to yield detailed flow patterns in the product during the pressing step. The composition comprised 52.5 wt % natural graphite powder, 31.5 wt % phenolic resin powder and 16 wt % milled graphite fiber.

This material was formed into a loaf material through a vacuum forming process similar to that of Example 1. Following the forming process, the material was dried and cut to the desired “green” dimensions and weight. The product was then hot pressed and carbonized as in Example 1.

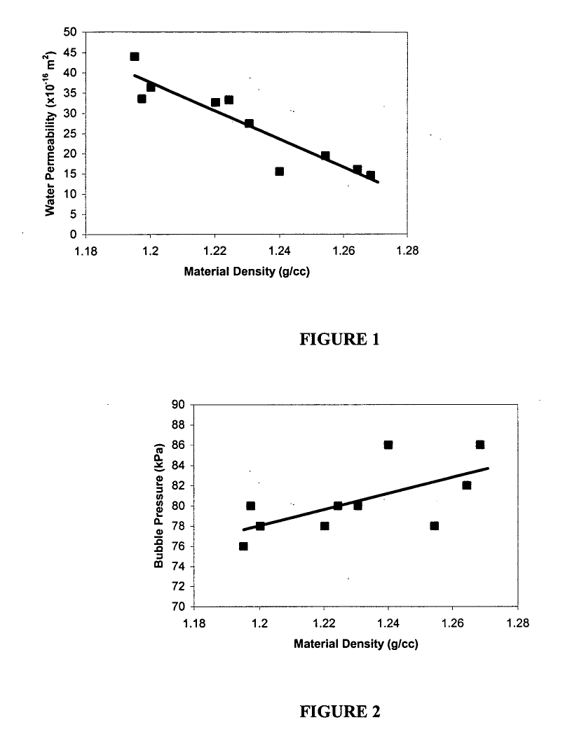

This product was made to have particular material porosity characteristics that are beneficial in the performance of a particular type of fuel cell. The porosity characteristics are measured through product water permeability and bubble pressure. For this type of material, the bubble pressure and permeability are highly dependent upon material density as is product strength, electrical conductivity and other material properties. FIGS. 1 and 2 show the density dependence of bubble pressure and permeability of this example material. This example shows that material porosity can be tailored through composition recipe and product density control.

### EXAMPLE 3

This example shows formulation of a net-shape molding product with the addition of a CVD seal. The composition comprised 55 wt % natural graphite powder; 28 wt % phenolic resin powder; 12.5 wt % milled graphite fiber, 2 wt % organic powder and 2.5 wt % chopped organic fibers.

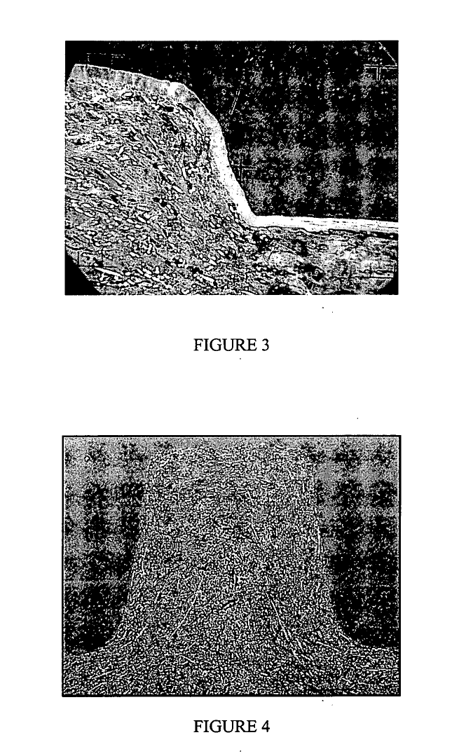

The product was formulated as above and molded in a hot patterned die. The part was then carbonized before applying the CVD coating similar to that described in example 1. This was done to provide a seal layer on the material surface. FIG. 3 is an optical micrograph of the sealed surface, showing the CVD sealing layer. In the figure, the light colored material following the part dimensional profile is the CVD coating layer.

### EXAMPLE 4

This example demonstrates the potential of molding the product to net or near-net shape. During molding, the ingredients in the material flow to fill the detail of the patterned mold plate. This composition comprised 50.5 wt % natural graphite powder; 25 wt % phenolic resin powder; 16 wt % milled graphite fiber and 8.5 wt % chopped organic fibers.

The organic fibers were added to the composition to aid in material flow during molding. FIG. 4 shows an example of the microstructure after processing. The material is shown to fill the mold, flowing into the channel regions. Ingredients flow during molding and follow the contours of the die.

### EXAMPLE 5

The benefit of using a flocculating agent to increase product drainage rate, material retention, and uniformity is demonstrated herein. In this example, two forming suspensions are compared with nominally identical recipes. The first contains no flocculating additive, while the second uses a flocculating additive. The composition comprised 54.5 wt % natural graphite powder; 30 wt % phenolic resin powder; 15 wt % milled graphite fiber; 0.5 wt % chopped organic fibers and 0.1 wt % MX-60 available from Cytec Industries, W. Paterson, N.J. as a flocculating additive. One batch of material was prepared without utilizing a flocculant additive, and the other with a flocculant additive. Results of processing are shown in Table 1.

| | With Flocculant | W/O Flocculant |
|---|---|---|
| Forming Time | 25 seconds | 3 minutes |
| Particle Retention | 95% | 85% |
| Uniformity | 2% | 2% |

The invention has been described with particular emphasis on the preferred embodiments without limit thereto. One of skill in the art would realize additional embodiments based on the teachings herein without departing from the scope of the invention as set forth in the claims appended hereto.

1. A carbon-based composite part comprising—
35 to 75 wt % graphite powder;
20 to 50 wt % resin powder; and
5 to 25 wt % discontinuous carbon fibers no longer than 3 mm.

2. A carbon-based composite part of claim 1 wherein said graphite powder comprises at least one of synthetic graphite and natural graphite.

3. A carbon-based composite part of claim 1 wherein said graphite powder has an average particle size between 1 and 200 μm.

4. A carbon-based composite part of claim 1 wherein said resin powder comprises at least one material selected from phenolic, pitch, mesophase pitch, epoxy, melamine, furfural and furan.

5. A carbon-based composite part of claim 1 wherein said resin produces a carbon char of at least 25 wt % on pyrolysis.

6. A carbon-based composite part of claim 1 wherein said discontinuous carbon fibers are ≦3 mm long and selected from the group consisting of PAN fibers, pitch fibers and mesophase pitch fibers.

7. A carbon-based composite part of claim 1 wherein said part has a density of between 0.4 and 1.6 g/cm³.

8. A carbon-based composite part of claim 1 wherein said part has a strength of at least 3000 psi at a density of 1.2 g/cm³.

9. A carbon-based composite part of claim 1 wherein the electrical conductivity is at least 150 S/cm at a density of 1.2 g/cm3.

10. A method for making a carbon-based composite comprising:
35 to 75 wt % graphite powder;
20 to 50 wt % resin powder which produces ≧25 wt % char on pyrolysis;
0 to 25 wt % discontinuous carbon fibers;
0 to 20 wt % addition of one or more fugitive forming fibers;
0 to 15 wt % addition of one or more fugitive thermoplastic polymer;
0 to 5 wt % addition of one or more flocculants;
0 to 1 wt % addition of one or more foam control agents; and
0 to 1 wt % addition of one of more wetting agents said method comprising:
mixing all components in an excess of water to produce a homogenous suspension;
filtering said suspension to form a filter cake;
drying said filter cake;
molding said filter cake under pressure at a specified temperature to form a desired shape; and
pyrolyzing said molded part at a temperature and for a time to substantially remove volatile components from the part.

11. The method of claim 10 wherein said forming fibers are selected from the group consisting of cellulose; cellulose derivatives; acrylic; modacrylic; polyolefin; polyester; nylon; polyvinyl alcohol; aramid and liquid crystal polymers.

12. The method of claim 10 wherein said forming fiber length is between 0.1 μm and 20 mm.

13. The method of claim 10 wherein said forming fiber diameter is between 0.1 μm and 50 μm.

14. The method of claim 10 wherein said thermoplastic polymer can be either particles or fibers.

15. The method of claim 10 wherein said thermoplastic polymer is selected from the group consisting of polyolefins, cellulosic polymers and phenoxy polymers.

16. The method of claim 10 wherein said flocculant is a high molecular weight polymer in solution.

17. The method of claim 16 wherein said flocculant is selected from polyacrylamide and polyethylene oxide polymers.

18. A molded carbon-based composite part comprising:
35 to 75 wt % graphite powder;
20 to 50 wt % resin powder; and
5 to 25 wt % discontinuous carbon fibers no longer than 3 mm; and
said fibers substantially following the surface contours of the part.

19. A molded carbon-based composite part of claim 18 wherein said graphite powder is one or more of the following: synthetic graphite, natural graphite.

20. A molded carbon-based composite part of claim 18 wherein said graphite powder has an average particle size between 1 and 200 μm.

21. A molded carbon-based composite part of claim 18 wherein said resin comprises at least one material selected from phenolic, pitch, mesophase pitch, epoxy, melamine, furfural and furan.

22. A molded carbon-based composite part of claim 18 wherein said resin produces a carbon char of at least 25 wt % on pyrolysis.

23. A molded carbon-based composite part of claim 18 wherein said discontinuous carbon fibers are ≦3 mm long and selected from the group consisting of PAN fibers, pitch fibers and mesophase pitch fibers.

24. A molded carbon-based composite part of claim 18 wherein said part has a density between 0.60 and 1.6 g/cm³.

25. A molded carbon-based composite part of claim 18 wherein said part has a strength of at least 3000 psi at a density of 1.2 g/cm³.

26. A molded carbon-based composite part of claim 18 wherein the electrical conductivity is at least 150 S/cm at a density of 1.2 g/cm3.
